(19) United States
(12) Patent Application Publication
(10) Pub. No.: US 2019/0236159 A1
(43) Pub. Date: Aug. 1, 2019

(54) KNOWLEDGE POWER DETECTOR

(71) Applicant: Salesforce.com, inc., San Francisco, CA (US)

(72) Inventors: Raksha Subramanyam, Fremont, CA (US); Aishwarya Kumar, Fremont, CA (US)

(21) Appl. No.: 15/885,619

(22) Filed: Jan. 31, 2018

(51) Int. Cl. G06F 17/30

(52) U.S. Cl. CPC G06F 17/3053; G06Q 10/1053; G06F 17/30554; G06F 17/3056

(57) ABSTRACT

Matching knowledge providers with knowledge consumers. Information corresponding to knowledge providers and information corresponding to knowledge consumers is managed in a database. Messages from remote electronic devices corresponding to the knowledge providers and the knowledge consumers are received. Subsequent information corresponding to the knowledge providers and the knowledge consumers is gathered from a plurality of remote platforms. Knowledge power agents configured to operate through the plurality of interfaces match knowledge providers with knowledge consumers based, at least in part, on shared interests, location and availability. In response to a match between at least one knowledge provider and at least one knowledge consumer, communicating via at least one of the plurality of interfaces information about the match to at least one knowledge consumer and at least one knowledge provider for which the match has been made.

### TECHNICAL FIELD

Embodiments relate to techniques for coordinating entities having knowledge to share with entities seeking to gain knowledge. More particularly, embodiments relate to techniques and architectures for maintaining information related to entities having knowledge to share with entities seeking to gain knowledge and strategies to efficiently match provider with consumers.

### BACKGROUND

There currently exist many people with many types of knowledge (e.g., computer programming expertise, financial expertise) as well as many people seeking additional knowledge in various areas. Currently, a person seeking additional information is required to attend a formal training/educational setting, or seek the knowledge independently through publications and self-directed learning. While these approaches can work, they do not provide an efficient transfer of knowledge.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment of a sign-in/registration screen and a knowledge profiteer home screen.

FIG. 2 is one embodiment of interests screens that can be utilized in the system described herein.

FIG. 3 is one embodiment of a map screen that can be utilized to locate relevant people, jobs and events.

FIG. 4 is an example availability listing that can be associated with a knowledge profiteer or contributor.

FIG. 5 is an example contributor profile page.

FIG. 6 is an example contributor profile page.

FIG. 7 is an example contributor profile page that includes availability information and/or feedback information.

FIG. 8 is an example alert configuration page.

FIG. 9 illustrates an example follower/following page and plugin management page.

FIG. 10 illustrates jobs and events pages.

FIG. 11 illustrates profiteer profile pages.

FIG. 12 illustrates an example a search interface.

FIG. 13 illustrates recommendations and interest update pages.

FIG. 14 is a block diagram of one embodiment of a system that can provide the functionality described herein.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In many different areas of knowledge (e.g., taxes, interior design, computer programming, gardening, database management, automobile maintenance, legal issues), there are people with different levels of expertise (“contributors”) and there are people who wish to gain further knowledge (“knowledge profiteers”). In some environments, for example, technical schools or universities, these roles are known and the path to increased knowledge is generally known to participants. However, in many other environments, the situation is more complex and it can be difficult for someone wanting to learn to connect with the best expert.

Described herein are various architectures, interfaces, strategies and other mechanisms that can match contributors with knowledge profiteers as well as facilitate connections and opportunities between them. In various embodiments, a person can be a contributor in one or more areas (e.g., JAVA programming, mobile app design) as a knowledge profiteer in one or more other areas (e.g., music history, home food preservation). In one embodiment, contributors and knowledge profiteers can utilize a mobile app to find knowledge consumers/providers and to facilitate the transfer of knowledge, for example, via a local meeting or video conference.

In one embodiment, the architecture utilized to provide matching and coordinating functionality can be a cloud-based architecture that can interact with any number of potential consumers and providers. Other architectures, for example, a mesh network of mobile devices can also be utilized.

The following example is provided based on the SALESFORCE platform, but this is merely one example of an environment in which the architectures and mechanisms described herein can be utilized. In one embodiment, a knowledge profiteer (a person who wishes to learn) can have interests matched with experts on the same platform (e.g., SALESFORCE) or on other platforms (e.g., LINKEDIN, QUORA, TWITTER). In one embodiment, the platform can provide a predefined set of interests that the user can choose from. In one embodiment, the interest list can change dynamically.

In one embodiment, one or more mechanisms/agents (described in greater detail below) can function to match the knowledge profiteer with an appropriate expert. Matching can be accomplished, for example, by finding the top N results with rankings based on a number of connections (e.g., LINKEDIN connections, CHATTER posts, TWITTER posts) in the appropriate domain(s) corresponding to the relevant interest. Other matching and ranking mechanisms can also be used.

Using LINKEDIN as an example, a list of company updates related to an interest area can be collected utilizing a REST API. Using a TWITTER example, posts can be searched utilizing a TWITTER API based on key words, @-mentions and/or tweet sources. Using a SALESFORCE example, a data store of people who have been designated as experts in a relevant field can be searched.

In one embodiment, manual entry of experts can be supported. In an alternate embodiment, third party expert listings can be utilized. Suggestions can be gathered and if a person or interest reached a specific threshold, that person can be added as an expert or a new interest can be added to the list (discussed above).

In one embodiment, a map web site (or app) can be utilized to indicate locations of experts, information seekers, teammates of experts, teammates of information seekers, etc. In one embodiment, the role of a person (expert, knowledge profiteer) can be color coded on the map. In one embodiment, the availability of the person on the map can be indicated by color, shape, icon, pop up, etc. In one embodiment, knowledge seekers actively meeting with experts can also be indicated on the map.

In one embodiment, one or more calendars (e.g., GOOGLE Calendar, ICAL) can be used to indicate availability of one or more parties. The information can be retrieved, for example, from public calendar entries, APIs into semi-public calendars, etc. In one embodiment, calendar entries, map markings and/or other indications of the experts can include (or have links to) publications by that expert.

In one embodiment, one or more mechanisms/agents (described in greater detail below) can function to search various platforms to find experts. In one embodiment, the results can be analyzed and ranked with the top M results being considered “experts” and those with lower rankings not being considered experts. Thus, the expert list can be automatically updated and/or can be dynamic.

In one embodiment, various mechanisms can be utilized to thank an expert for sharing knowledge. These mechanisms can include, for example, a meme, lunch, dinner, coffee, a drink, feedback, star ratings, email message, social media post, etc. In one embodiment, meetings, events, conferences can be monitored for matching interests and information seekers with appropriate interests can be notified of the meetings, events, conferences, etc. In one embodiment, suggestions/recommendations/matches can be based on email or social media message/post analysis.

In one embodiment, a contributor is a person who teaches or mentors others about one or more interests. In one embodiment, the system can gather information from multiple sources/platforms to determine the contributors ability to share knowledge corresponding to an interest (e.g., in terms of availability, depth of knowledge, experience, teaching ability). This information can be used to match the contributor with one or more knowledge profiteers.

In one embodiment, the system can facilitate meetings between knowledge providers and knowledge consumers utilizing, for example, calendar (GOOGLE Calendar, ICAL) APIs, FACEBOOK APIs (to find events listed on FACEBOOK), LINKEDIN APIs, GOOGLE+, CHATTER, etc. In one embodiment, blogs, books, articles, projects, social media posts and other sources of recorded expertise can be searched and/or analyzed to find experts or to determine is a person should be considered an expert. In one embodiment, the analysis and evaluation described herein can be periodically (or constantly) updated to provide both experts and knowledge profiteers with current information.

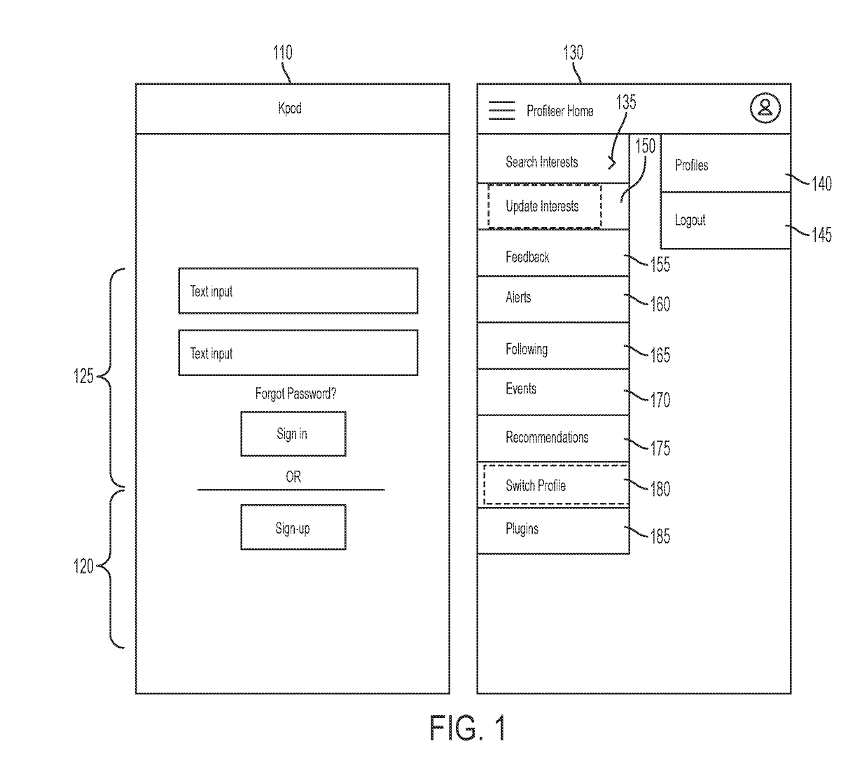

FIG. 1 is one embodiment of a sign-in/registration screen and a knowledge profiteer home screen. The screenshots of FIG. 1 are examples and many other configurations can also be supported.

In one embodiment, sign-up/sign-in screen 110 allows a new user to start the sign-up process using sign-up portion 120 or allows a returning user to enter the system using sign-in portion 125. In one embodiment, once signed in, a user (in this example, a knowledge profiteer) works from home screen 130. The user can have one or more profiles accessed via profiles link 140, and the user can have the option to logout using logout link 145.

In one embodiment, home screen 130 provides an option to search interests 135 that are available. Interests are the type of knowledge that the knowledge profiteer can seek. Search functionality 135 provides the ability to select one or more topics of interest. Various search interfaces and techniques can be utilized. Search and selection of interests is described in greater detail below.

In one embodiment, a user can have the option to update interests, 150, for example, as their interests evolve and/or situation changes. In one embodiment, the user can provide feedback, 155, either to system administrators and/or contributors. Alerts (or notifications) can be managed, 160, to inform the user about, for example, new interests or unexplored interests that might be relevant to the user.

In one embodiment, the user can have the option to follow, 165, one or more other contributors, knowledge profiteers, venues, groups, etc. In one embodiment, the user can have the option to be informed of, or register for, one or more events, 170. The events can be, for example, gatherings of people with the same or similar interests.

In one embodiment, the system can provide recommendations to the user, 175, based on, for example, selected interests, nearby events, related interests, etc. In one embodiment, the user can have the option of switching between multiple profiles, 180, for example, a professional profile and a personal profile. In one embodiment, the user can have the ability to manage one or more plugins, 185, that can be utilized to enhance the functionality of the knowledge detection system.

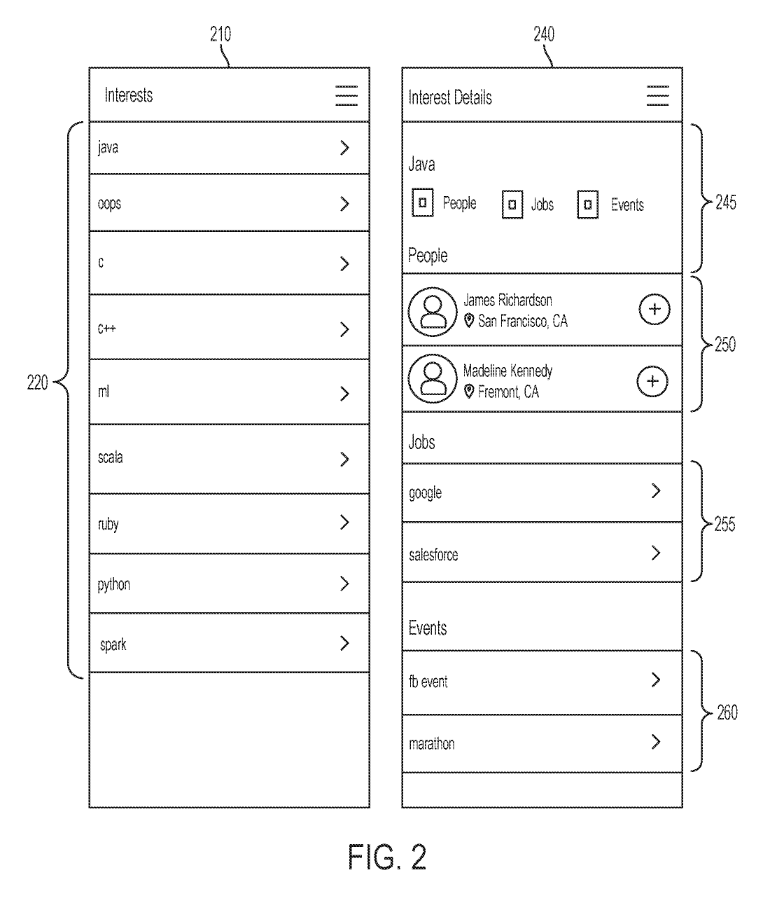

FIG. 2 is one embodiment of interests screens that can be utilized in the system described herein. Interests screen 210 can be accessed, for example, through a search interest interface (e.g., 135 of FIG. 1) or through an update interests interface (e.g., 150 of FIG. 1). In one embodiment, Interests interface 210 can include one or more topics 220 that can be of interest to the user (e.g., JAVA, OOPS, C, C++). In one embodiment, the user can select one of the available interests to move to interest details screen 240.

In one embodiment, the user can utilize interest details screen 240 to select one or more categories, 245, relevant to the interest (e.g., people, jobs, events). In one embodiment, one or more people can be listed, 250. The listing of people can be, for example, local contributors that are available to share knowledge related to the selected interest. In one embodiment, one or more jobs can be listed, 255. The jobs can be in the area of interest and have requirements similar to the user. In one embodiment, one or more events, 260, related to the selected interest can be listed.

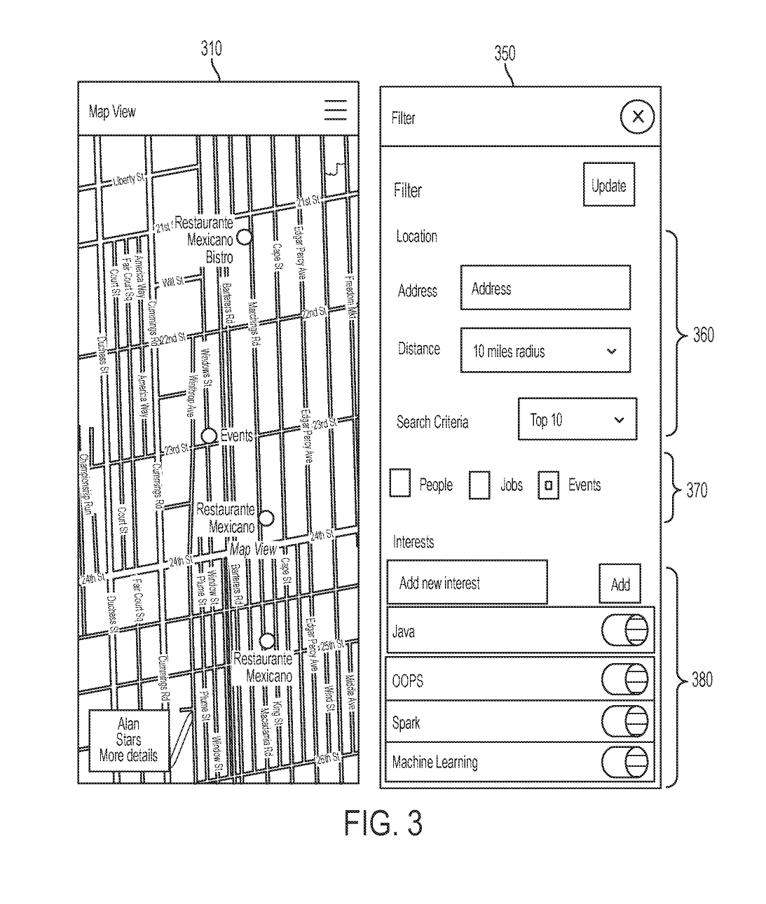

FIG. 3 is one embodiment of a map screen that can be utilized to locate relevant people, jobs and events. In the example of FIG. 3, map 310 can provide geographical information related to a selected interest. Map 310 can be based on a current user's location (e.g., using mobile device location services) or can be based on an alternate location selected by the user.

In one embodiment, filter screen 350 allows the user to filter the information provided on map screen 310 based on various criteria. The filtering criteria can be based on location, 360, which can include, for example, an address, a distance from the address and a number of items to include. Alternatively, additional and/or different location filters can be supported. In one embodiment, the user can select types of items listed on the map, 310, which can include, for example, people, jobs and/or events 370. In one embodiment, the user can select one or more interests, 380, for which the above filtered information can be provided. Thus, use of map 310 can allow the user to visualize where different knowledge can be shared.

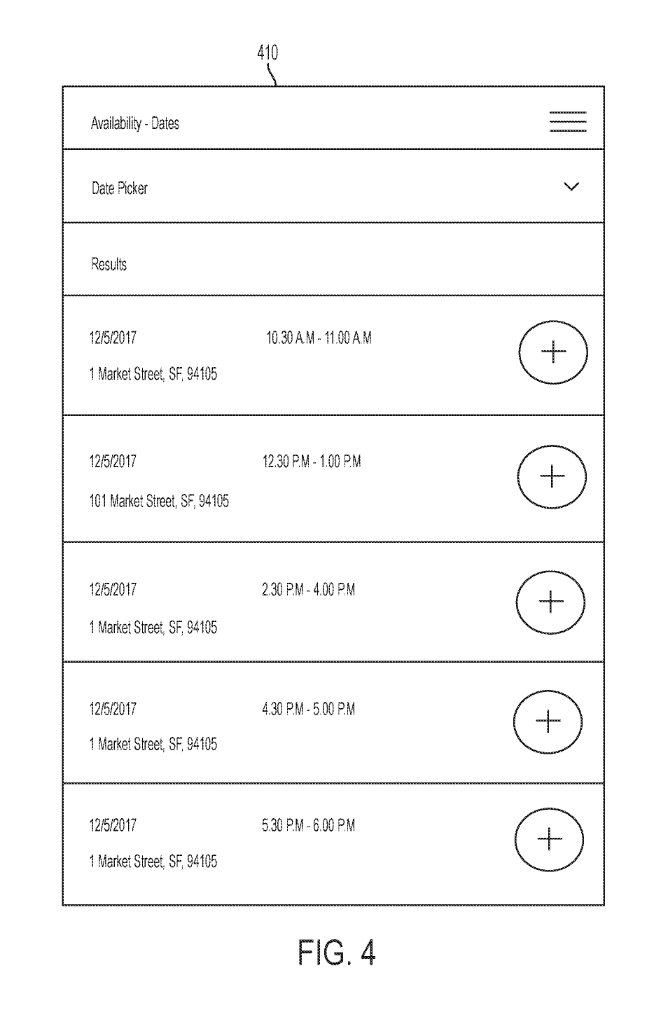

FIG. 4 is an example availability listing, 410, that can be associated with a knowledge profiteer or contributor. The availability listing can be for a knowledge profiteer (consumer) or for at knowledge contributor (provider) and can be provided to allow other parties to select a time to share knowledge. The availability listing can also be associated with a map, for example, certain times and certain places. These can be classified as events or can be configured by the individuals based on specific schedules.

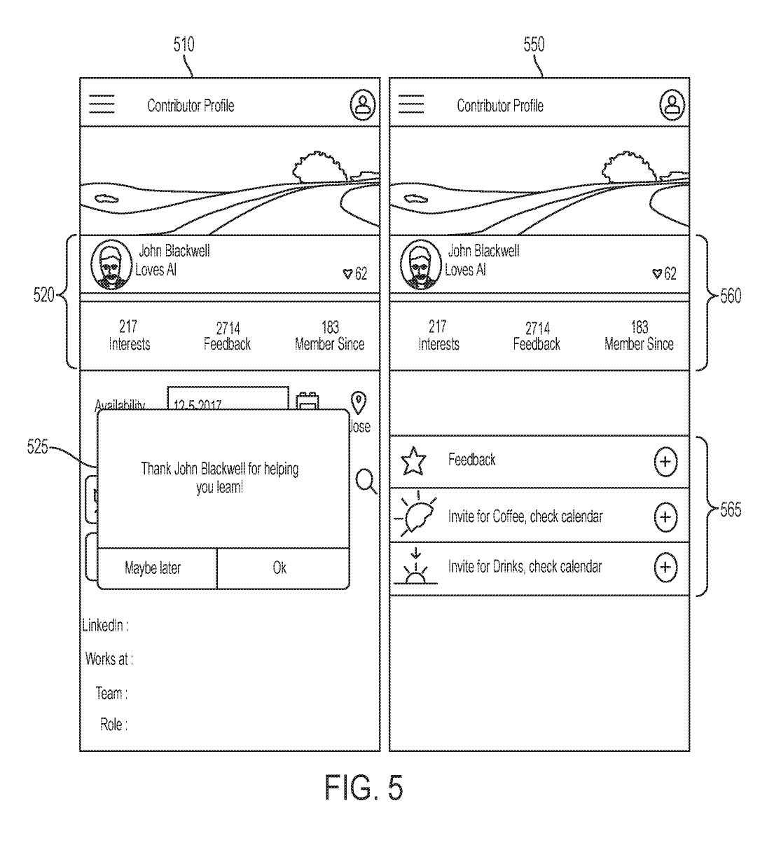

FIG. 5 is an example contributor profile page. In one embodiment, contributor profile page 510 can provide profile information, 520, for the contributor. This profile information can include, for example, how many interests the contributor has selected, how many feedback entries the contributor has, how long the contributor has been a member of the community, etc. In one embodiment, each of these items can be links to more detailed information. For example, clicking on the number of feedback entries can take a user to a listing of the feedback entries so that the user can read the individual entries.

In one embodiment, contributor profile page 510 can include thank you mechanism, 525, to allow a knowledge profiteer to thank the contributor. The example of FIG. 5 does not include any monetization mechanisms; however, in alternate embodiments, the system can include a payment and/or billing mechanism to allow for monetization of the knowledge transfer process.

In another embodiment, contributor profile page 550 can provide profile information, 560, for the contributor. This profile information can include, for example, how many interests the contributor has selected, how many feedback entries the contributor has, how long the contributor has been a member of the community, etc. In one embodiment, each of these items can be links to more detailed information. For example, clicking on the number of feedback entries can take a user to a listing of the feedback entries so that the user can read the individual entries.

In one embodiment, page 550 can include response mechanism 565. In one embodiment, a knowledge profiteer can thank the contributor by selecting one or more options from response mechanism 565. The example of FIG. 5 includes, feedback, invite for coffee and invite for drinks. These are just example options and additional and/or different options (e.g., monetization) can also be supported. In one embodiment, response mechanism can work with a calendar to determine the contributor's availability for the selected response (e.g., invite for coffee).

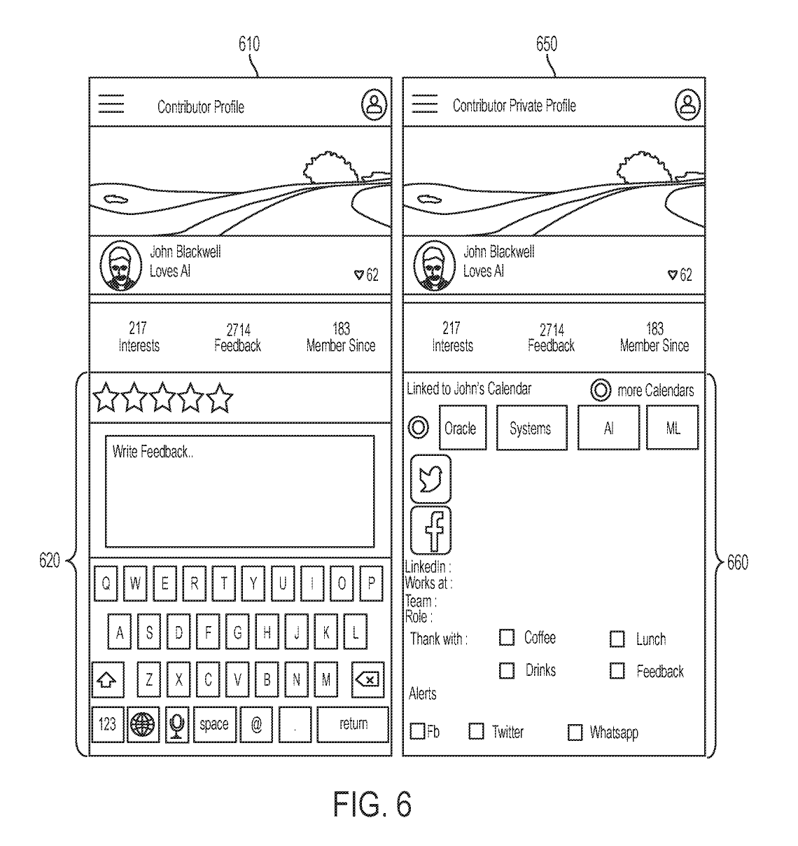

FIG. 6 is an example contributor profile page. Page 610 illustrates an example contributor profile page through which a user can provide feedback, 620, in the form of a star rating and/or written feedback. Additional and/or different feedback mechanisms can also be supported.

In one embodiment, a contributor can have private profile page 650 to control one or more components of the contributor's public profile, 660. For example, the contributor can control access to his/her calendar and/or what types of entries can be made on the calendar. The contributor can choose one or more ways for a knowledge profiteer to thank them (e.g., coffee, lunch, drinks, feedback). The contributor can also control what types of alerts they receive and how they receive the alerts (e.g., FACEBOOK, TWITTER, WHATSAPP).

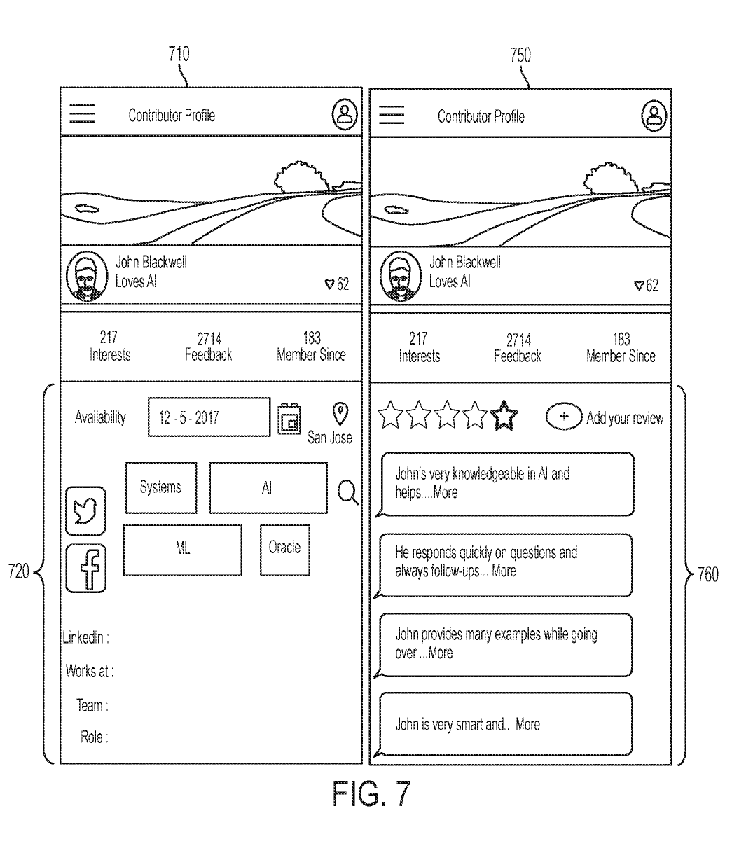

FIG. 7 is an example contributor profile page that includes availability information and/or feedback information. In one embodiment, contributor profile 710 allows the contributor to provide availability information, 720, for example, date, time, location, interests, communication channels (e.g., FACEBOOK, TWITTER), etc. In one embodiment, additional information about the contributor, for example, LINKEDIN profile, current employment, role and/or other relevant information can be included in contributor profile 710. In one embodiment, contributor profile 750 can include specific feedback left for the contributor and/or a cumulative star rating, 760.

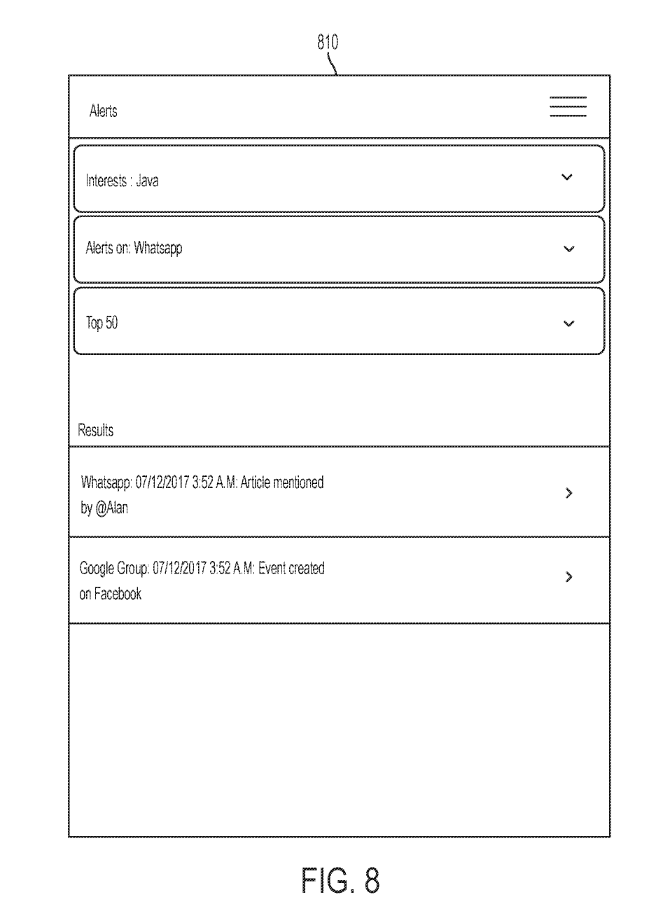

FIG. 8 is an example alert configuration page, 810. The example of FIG. 8 allows a user to configure alerts based on, for example, one or more interests (e.g., JAVA), a platform to receive alerts (e.g., WHATSAPP), how many alerts, etc. Additional and/or different alert characteristics can be supported.

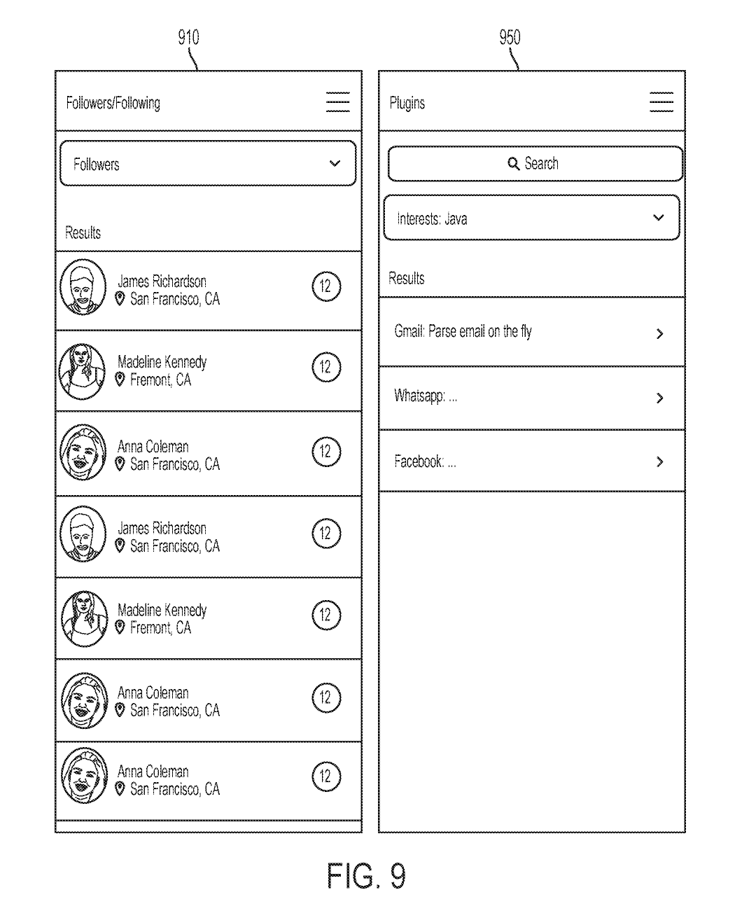

FIG. 9 illustrates an example follower/following page and plugin management page. In one embodiment, a user can utilize follower/following page 910 to follow others, manage followers and/or gather additional information about followers and/or people who are being followed. In one embodiment, page 950 allows an interface for management of plugins and/or additional functionality features.

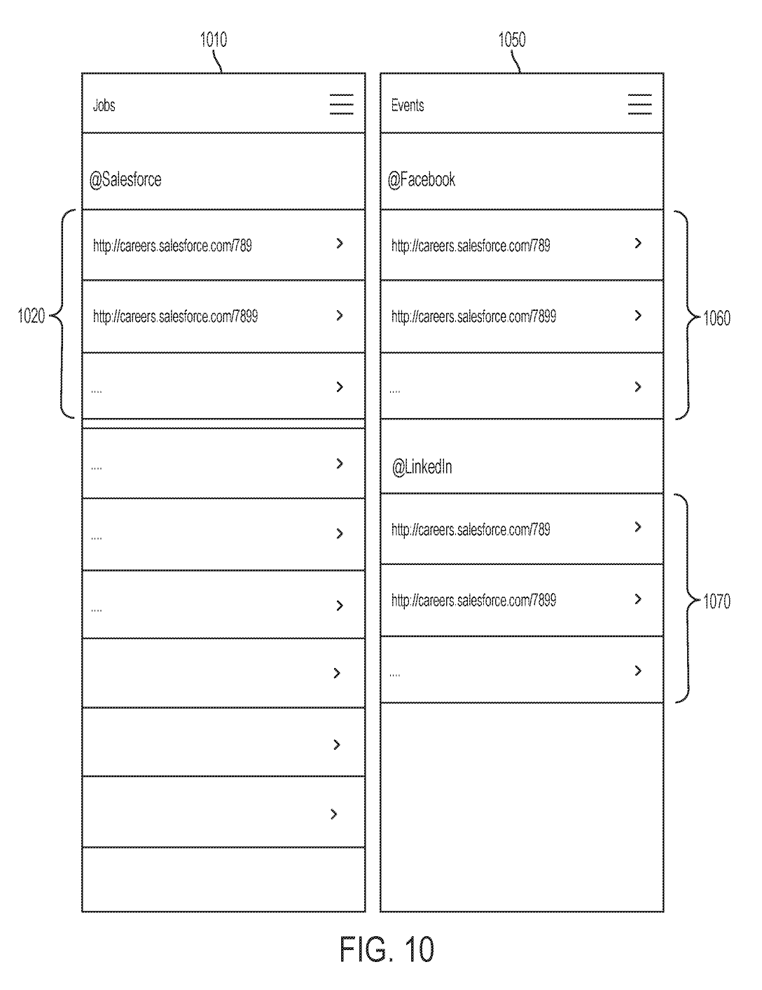

FIG. 10 illustrates jobs, 1010, and events, 1050, pages. In one embodiment, page 1010 provides a listing of jobs, 1020, that are related to relevant interests. For example, if a user has an interest in JAVA, job openings for JAVA programmers can be listed. In one embodiment, one or more relevant events 1060 and 1070 can be listed via different platforms (e.g., FACEBOOK, LINKEDIN).

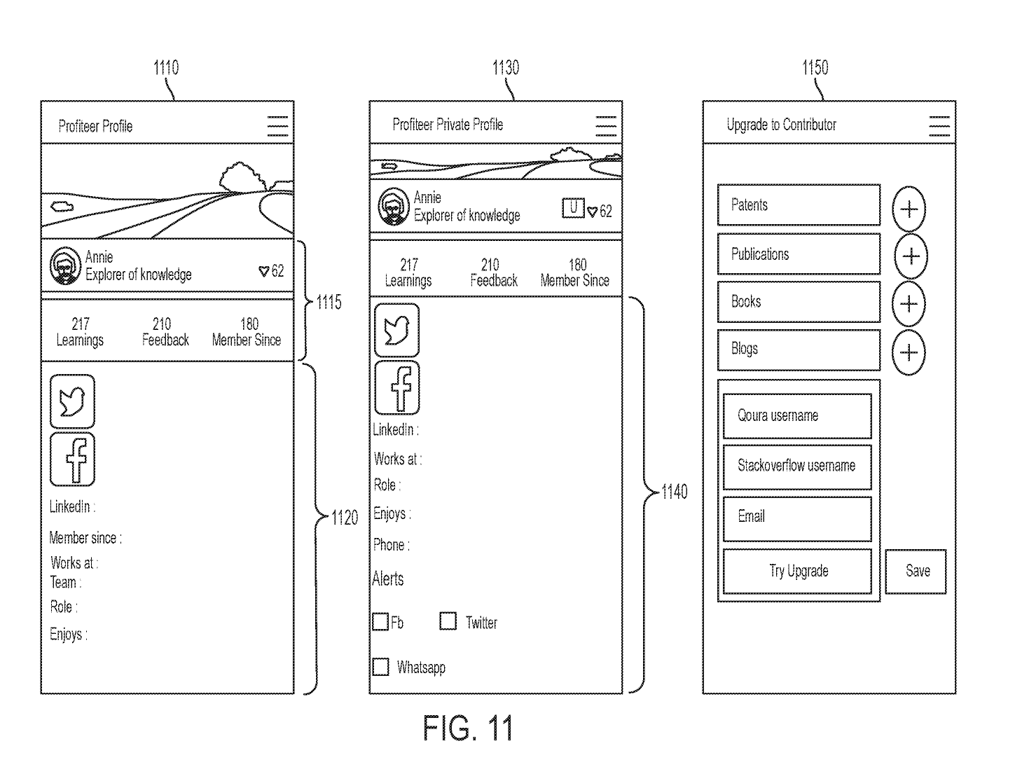

FIG. 11 illustrates profiteer profile pages. In one embodiment, profiteer profile page 1110 is similar to the contributor profile page discussed above. Page 1110 can include profile information, 1115, such as, for example, a number of knowledge/learning transactions participated in, feedback given or received, a member time frame and/or other relevant information. Page 1110 can further include contact information, 1120, including, for example, TWITTER handle, FACEBOOK page, LINKEDIN page, employment information, etc.

In one embodiment, a profiteer can have private profile page 1130 to control one or more components of the individual's public profile, 1140. For example, the contributor can control access to his/her calendar and/or what types of entries can be made on the calendar. The contributor can choose one or more ways for a knowledge profiteer to thank them (e.g., coffee, lunch, payment, feedback). The profiteer can also control what types of alerts they receive and how they receive the alerts (e.g., FACEBOOK, TWITTER, WHATSAPP).

In one embodiment, the profiteer can upgrade to contributor through page 1150 and can include relevant expertise information including, for example, patents acquired, publications, books, blogs, community user names, email addresses, etc.

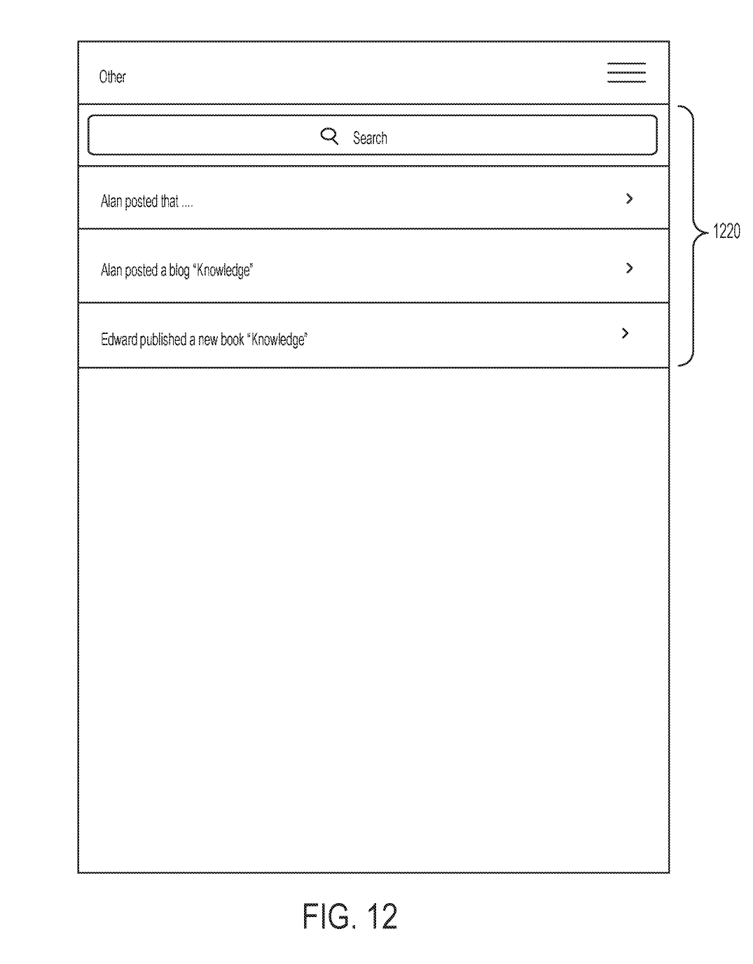

FIG. 12 illustrates an example a search interface. In one embodiment, 1220 a user can search for various terms, interests, etc. In one embodiment, suggestions or recommendations can be provided through search interface 1220.

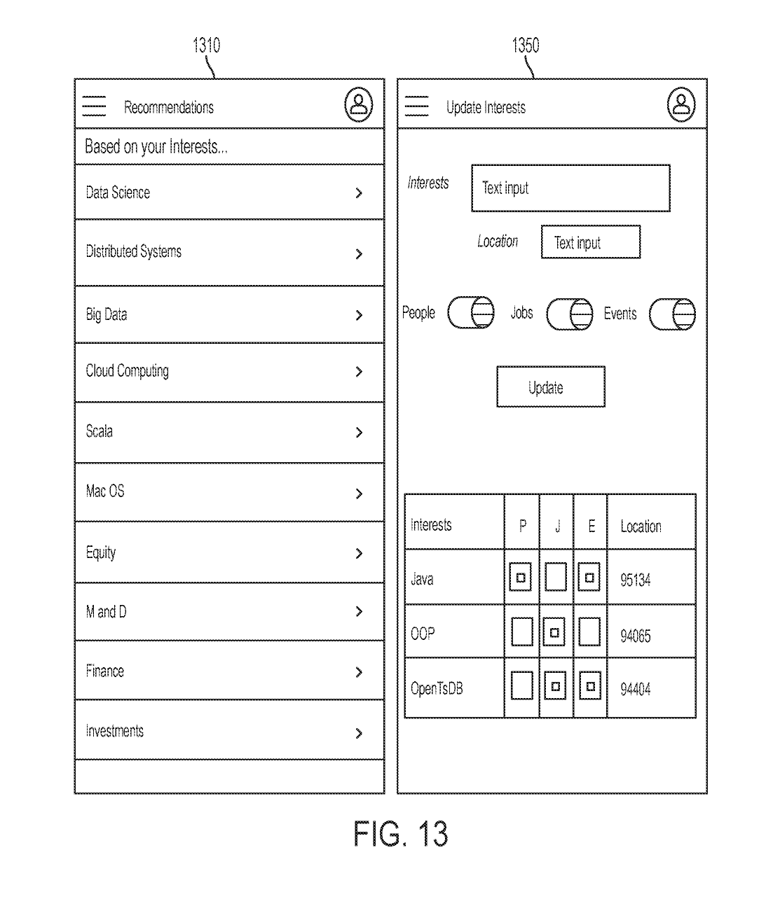

FIG. 13 illustrates recommendations and interest update pages. In one embodiment, one or more recommendations can be presented to the user, page 1310, based on, for example, interests related to user interests, trending topics, search history, etc. In one embodiment, page 1350 can be utilized to update interest information, for example, by updating interests, locations, etc.

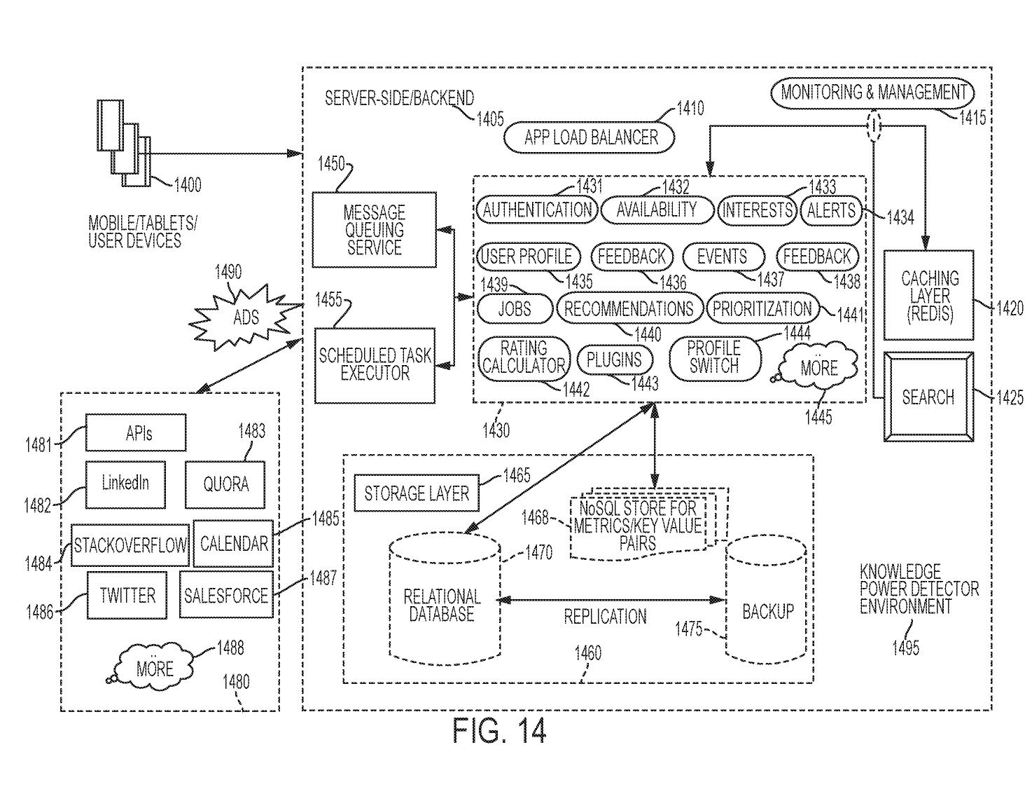

FIG. 14 is a block diagram of one embodiment of a system that can provide the functionality described herein. The example of FIG. 14 corresponds to a cloud-based architecture; however, other configurations can also be supported.

In one embodiment, any number of mobile devices, tablets, wearable computing devices, user devices (e.g., laptop, desktop), and/or other electronic computing devices, 1400, can be supported. In one embodiment, knowledge power detector environment 1495 provides most or all of the functionality to provide described herein.

In one embodiment, knowledge power detector environment 1495 includes database system 1460, which includes storage layer 1465 to manage data storage functionality, relational database 1470 and backup database 1475. In one embodiment, database system further includes NoSQL store 1468 for metrics and/or key value pair storage. In various embodiments, database system 1460 provides the database storage and data management to support the knowledge sharing functionality described herein. For example, users and their associated interests, preference, historical activity, etc. can be stored and managed within database system 1460.

In one embodiment, knowledge power detector environment 1495 includes server-side/backend hardware and software 1405 to provide an interface between knowledge power detector environment 1495 and devices 1400. In one embodiment, knowledge power detector environment 1495 includes app load balancer 1410 that operates to manage load distribution among the resources of knowledge power detector environment 1495.

In one embodiment, knowledge power detector environment 1495 includes monitoring and management module 1415 to provide monitoring and control functionality within knowledge power detector environment 1495. In one embodiment, knowledge power detector environment 1495 includes caching layer 1420 that is coupled with and controlled by monitoring and management module 1415. In one embodiment, knowledge power detector environment 1495 further includes search module 1425, which operates to provide search functionality as described herein.

In one embodiment, knowledge power detector environment 1495 includes message queuing serve 1450 to manage messages between components of knowledge power detector environment 1495, devices 1400 and application program interfaces (APIs) 1480. In one embodiment, knowledge power detector environment 1495 includes scheduled task executor 1455 to schedule and manage tasks and messages with message queuing service 1450.

In one embodiment, knowledge power detector environment 1495 includes knowledge power detector 1430, which further includes several agents to provide the functionality described herein. In one embodiment, authentication agent 1431 operates to provide authentication services to users attempting to access knowledge power detector environment 1495 and/or associated functionality or components. In one embodiment, availability agent 1432 operates to determine and/or coordinate availability of consumers and producers of knowledge using knowledge power detector environment 1495.

In one embodiment, interests agent 1433 operates to manage interest categories, definitions, availability and/or other functionality associated with interests as described herein. In one embodiment, alerts agent 1434 operates to manage alert categories, definitions and/or other functionality associated with alerts as described herein.

In one embodiment, user profile agent 1435 operates to manage user profiles and/or other functionality associated with user profiles as described herein. In one embodiment, feedback agent 1436 operates to manage feedback collection, publishing, analysis, presentation and/or other functionality associated with feedback as described herein.

In one embodiment, events agent 1437 operates to manage event communication, presentation, distribution, approval and/or other functionality associated with events as described herein. In one embodiment, feedback agent 1438 operates to manage feedback collection, publishing, analysis, presentation and/or other functionality associated with feedback as described herein.

In one embodiment, jobs agent 1439 operates to manage job description collection, publishing, analysis, matching, presentation and/or other functionality associated with jobs as described herein. In one embodiment, recommendations agent 1440 operates to manage recommendation creation, analysis, presentation and/or other functionality associated with recommendations as described herein.

In one embodiment, prioritization agent 1441 operates to manage prioritization, analysis, presentation and/or other operations with respect to prioritization of information presented to users as described herein. In one embodiment, rating calculator agent 1442 operates to manage rating collection, publishing, analysis, presentation and/or other functionality associated with ratings as described herein.

In one embodiment, plugins agent 1443 operates to manage plugin operation, publishing, analysis, and/or other functionality associated with plugins as described herein. In one embodiment, profile switch agent 1444 operates to manage plugins as described herein. Additional and/or different functional agents 1445 can also be included.

In one embodiment, various APIs 1480 can be utilized to gather information from and/or provide information to third party platforms including, for example, LINKEDIN 1482, QUORA 1483, STACKOVERFLOW 1484, Calendars (e.g., GOOGLE, ICAL) 1485, TWITTER 1486, SALESFORCE 1487, and/or other platforms 1488. In one embodiment, advertising, 1490, can be utilized to provide a revenue stream for one or more of the parties involved with the architecture of FIG. 14.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A system comprising:
a database system having at least one storage device to provide a database, the database to store information corresponding to knowledge providers and to store information related to knowledge consumers;
one or more hardware processors coupled with the database to at least manage the information corresponding to the knowledge providers and information corresponding to the knowledge consumers;
a plurality of interfaces communicatively coupled with the one or more hardware processors, the interfaces to receive messages from remote electronic devices corresponding to the knowledge providers and the knowledge consumers and to gather information from a plurality of platforms;
a plurality of knowledge power agents configured to operate through the plurality of interfaces with the one or more hardware processors and the database system to match knowledge providers with knowledge consumers based, at least in part, on shared interests, location and availability;
wherein, in response to a match between at least one knowledge provider and at least one knowledge consumer, the one or more processors to communicate via at least one of the plurality of interfaces information about the match to at least one knowledge consumer and at least one knowledge provider for which the match has been made.

2. The system of claim 1 further comprising finding job openings via the plurality of interfaces to present to knowledge providers based, at least in part, on identified interests.

3. The system of claim 1 further comprising finding job openings via the plurality of interfaces to present to knowledge consumers based, at least in part, on identified interests.

4. The system of claim 1 wherein the knowledge power agents are further configured to match availability of knowledge providers and knowledge consumers utilizing calendars corresponding to the knowledge providers and the knowledge consumers.

5. The system of claim 1 wherein the one or more hardware processors are configurable to:
utilize the plurality of interfaces to search one or more platforms for information corresponding to a selected interest and one or more potential knowledge providers;
analyze results from the searches based on one or more pre-selected criteria related to the selected interest;
generate a ranking of the one or more potential knowledge providers based on results from the analysis;
designate a selected group of one or more of the potential knowledge providers as knowledge providers based on the ranking.

6. The system of claim 1 wherein the knowledge power agents are further configured to match availability of knowledge providers and knowledge consumers utilizing geographical locations corresponding to the knowledge providers and the knowledge consumers.

7. The system of claim 6 wherein one or more of the geographical locations are presented on a map via one or more of the remote electronic devices.

8. A non-transitory computer-readable medium having stored thereon instructions that, when executed by one or more processors, are configurable to cause the one or more processors to:
manage information corresponding to knowledge providers and information corresponding to knowledge consumers in a database maintained on at least one storage device;
receive messages from remote electronic devices corresponding to the knowledge providers and the knowledge consumers;
gather subsequent information corresponding to the knowledge providers and the knowledge consumers from a plurality of remote platforms;
utilize a plurality of knowledge power agents configured to operate through the plurality of interfaces to match knowledge providers with knowledge consumers based, at least in part, on shared interests, location and availability;
in response to a match between at least one knowledge provider and at least one knowledge consumer, the one or more processors to communicate via at least one of the plurality of interfaces information about the match to at least one knowledge consumer and at least one knowledge provider for which the match has been made.

9. The non-transitory computer-readable medium of claim 8 further comprising instructions that, when executed by the one or more processors, are configurable to cause the one or more processors to find job openings via the plurality of interfaces to present to knowledge providers based, at least in part, on identified interests.

10. The non-transitory computer-readable medium of claim 8 further comprising instructions that, when executed by the one or more processors, are configurable to cause the one or more processors to find job openings via the plurality of interfaces to present to knowledge consumers based, at least in part, on identified interests.

11. The non-transitory computer-readable medium of claim 8 wherein the knowledge power agents are further configured to match availability of knowledge providers and knowledge consumers utilizing calendars corresponding to the knowledge providers and the knowledge consumers.

12. The non-transitory computer-readable medium of claim 8 wherein the one or more hardware processors are configurable to:
utilize the plurality of interfaces to search one or more platforms for information corresponding to a selected interest and one or more potential knowledge providers;
analyze results from the searches based on one or more pre-selected criteria related to the selected interest;
generate a ranking of the one or more potential knowledge providers based on results from the analysis;
designate a selected group of one or more of the potential knowledge providers as knowledge providers based on the ranking.

13. The non-transitory computer-readable medium of claim 8 wherein the knowledge power agents are further configured to match availability of knowledge providers and knowledge consumers utilizing geographical locations corresponding to the knowledge providers and the knowledge consumers.

14. The non-transitory computer-readable medium of claim 13 wherein one or more of the geographical locations are presented on a map via one or more of the remote electronic devices.

15. A method comprising:
managing information corresponding to knowledge providers and information corresponding to knowledge consumers in a database maintained on at least one storage device;
receiving messages from remote electronic devices corresponding to the knowledge providers and the knowledge consumers;
gathering subsequent information corresponding to the knowledge providers and the knowledge consumers from a plurality of remote platforms;
utilizing a plurality of knowledge power agents configured to operate through the plurality of interfaces to match knowledge providers with knowledge consumers based, at least in part, on shared interests, location and availability;
in response to a match between at least one knowledge provider and at least one knowledge consumer, communicating via at least one of the plurality of interfaces information about the match to at least one knowledge consumer and at least one knowledge provider for which the match has been made.

16. The method of claim 15 further comprising finding job openings via the plurality of interfaces to present to knowledge providers based, at least in part, on identified interests.

17. The method of claim 15 further comprising finding job openings via the plurality of interfaces to present to knowledge consumers based, at least in part, on identified interests.

18. The method of claim 15 wherein the knowledge power agents are further configured to match availability of knowledge providers and knowledge consumers utilizing calendars corresponding to the knowledge providers and the knowledge consumers.

19. The method of claim 15 further comprising:
utilizing the plurality of interfaces to search one or more platforms for information corresponding to a selected interest and one or more potential knowledge providers;
analyzing results from the searches based on one or more pre-selected criteria related to the selected interest;
generating a ranking of the one or more potential knowledge providers based on results from the analysis;
designating a selected group of one or more of the potential knowledge providers as knowledge providers based on the ranking.

20. The method of claim 15 wherein the knowledge power agents are further configured to match availability of knowledge providers and knowledge consumers utilizing geographical locations corresponding to the knowledge providers and the knowledge consumers.

21. The method of claim 20 wherein one or more of the geographical locations are presented on a map via one or more of the remote electronic devices.
